(19) United States
(12) Patent Application Publication
(10) Pub. No.: US 2016/0196853 A1
(43) Pub. Date: Jul. 7, 2016

(54) MODULARIZED INFORMATION PLAYBACK DEVICE

(71) Applicant: DASHBON, INC., New Taipei City (TW)

(72) Inventors: SHIH-TA LIN, NEW TAIPEI CITY (TW); CHIEN-WEN HSU, NEW TAIPEI CITY (TW); PO-LIN WANG, NEW TAIPEI CITY (TW); CHING-TE CHU, NEW TAIPEI CITY (TW); CHEN-AN WU, NEW TAIPEI CITY (TW); HUNG-CHANG YEH, NEW TAIPEI CITY (TW)

(21) Appl. No.: 14/974,508

(22) Filed: Dec. 18, 2015

(30) Foreign Application Priority Data
Jan. 5, 2015 (TW) 104200035

(51) Int. Cl. G11B 33/02; G11B 33/06; G11B 31/00

(52) U.S. Cl. CPC G11B 33/025; G11B 31/00; G11B 33/06

(57) ABSTRACT

A modularized information playback device includes a casing module, a control circuit module, a microprojector module, a speaker module, an audio frequency receiving module, and a wireless transmission module. The casing module includes a first network structure, an image projection opening, and an audio frequency receiving opening. The control circuit module is disposed inside the casing module. The microprojector module is disposed inside the casing module, and the microprojector module includes a projection lens assembly partially exposed from the image projection opening. The speaker module is disposed inside the casing module, and the speaker module is adjacent to the first network structure. The audio frequency receiving module is disposed inside the casing module, and the audio frequency receiving module is adjacent to the audio frequency receiving opening. The wireless transmission module is disposed inside the casing module.

### BACKGROUND OF THE INVENTION

1. Field of the Invention

The instant disclosure relates to an information playback device, and more particularly to a modularized information playback device.

2. Description of Related Art

In the modern information age we live in today, we are able to carry different types of data, information, news reports, knowledge and ideas in the form of digital media/multimedia files. It can then be played or reproduced by using a playback system which includes the data source unit and the playback unit. The data source unit using digital media/multimedia files as the signal sources for the playback unit, and also the playback unit includes the speakers and the display device that turns the source signal into the form of voice and videos. As a result of the fast growing modern information technology and its universal application, the form of data source unit becomes more diversified. For example, the data source unit can be in the form of Digital Versatile Disc (DVD) player, or disc record/playback devices, or blue-ray disc player, or blue-ray record/playback devices, or modem receives multimedia files via cable or wireless internet and the set top box, multimedia player devices that can read multimedia data via hard disk, flash memory card or memory card, game console, or even with digital camera, camcorder and mobile phones and any handheld devices that have voice/video output functions. The playback unit can be in the form of sound system, monitors, TV unit or overhand projectors.

### SUMMARY OF THE INVENTION

One aspect of the instant disclosure relates to a modularized information playback device.

One of the embodiments of the instant disclosure provides a modularized information playback device, comprising: a casing module, a control circuit module, a microprojector module, a speaker module, an audio frequency receiving module, a wireless transmission module, and a rechargeable battery module. The casing module has a first surface, a second surface opposite to the first surface, and a third surface connected between the first surface and the second surface, and the casing module includes a first network structure disposed on the first surface, a second network structure disposed on the second surface, an image projection opening disposed on the second surface, and an audio frequency receiving opening disposed on the third surface. The control circuit module is disposed inside the casing module. The microprojector module is disposed inside the casing module and electrically connected to the control circuit module, wherein the microprojector module includes a projection lens assembly partially exposed from the image projection opening. The speaker module is disposed inside the casing module and electrically connected to the control circuit module, and the speaker module is adjacent to the first network structure. The audio frequency receiving module is disposed inside the casing module and electrically connected to the control circuit module, and the audio frequency receiving module is adjacent to the audio frequency receiving opening. The wireless transmission module is disposed inside the casing module and electrically connected to the control circuit module. The rechargeable battery module is disposed inside the casing module and electrically connected to the control circuit module.

More particularly, the modularized information playback device further comprising: an electrical connector module disposed on the second surface of the casing module and electrically connected to the control circuit module, wherein the electrical connector module includes an image and audio signal transmission interface, an audio signal transmission interface, an audio signal output interface, a power input interface, a power output interface, and a messaging application programming interface.

More particularly, the modularized information playback device further comprising: a key module disposed on the third surface of the casing module and electrically connected to the control circuit module, wherein the key module includes a plurality of function keys disposed on the third surface of the casing module.

More particularly, the modularized information playback device further comprising: a light indicating module disposed on the third surface of the casing module and electrically connected to the control circuit module, wherein the light indicating module includes a plurality of indicator lamps disposed on the third surface of the casing module.

Another one of the embodiments of the instant disclosure provides a modularized information playback device, comprising: a casing module, a control circuit module, a microprojector module, a speaker module, an audio frequency receiving module, and a wireless transmission module. The casing module includes a first network structure, an image projection opening, and an audio frequency receiving opening. The control circuit module is disposed inside the casing module. The microprojector module is disposed inside the casing module and electrically connected to the control circuit module, and the microprojector module includes a projection lens assembly partially exposed from the image projection opening. The speaker module is disposed inside the casing module and electrically connected to the control circuit module, and the speaker module is adjacent to the first network structure. The audio frequency receiving module is disposed inside the casing module and electrically connected to the control circuit module, and the audio frequency receiving module is adjacent to the audio frequency receiving opening. The wireless transmission module is disposed inside the casing module and electrically connected to the control circuit module.

Yet another one of the embodiments of the instant disclosure provides a modularized information playback device, comprising: a casing module, a control circuit module, a microprojector module, a speaker module, an audio frequency receiving module, a wireless transmission module, a rechargeable battery module, an electrical connector module, a key module, and a light indicating module. The control circuit module is disposed inside the casing module. The microprojector module is disposed inside the casing module and electrically connected to the control circuit module. The speaker module is disposed inside the casing module and electrically connected to the control circuit module. The audio frequency receiving module is disposed inside the casing module and electrically connected to the control circuit module. The wireless transmission module is disposed inside the casing module and electrically connected to the control circuit module. The rechargeable battery module is disposed inside the casing module and electrically connected to the control circuit module. The electrical connector module is disposed on the casing module and electrically connected to the control circuit module. The key module is disposed on the casing module and electrically connected to the control circuit module. The light indicating module is disposed on the casing module and electrically connected to the control circuit module.

To further understand the techniques, means and effects of the instant disclosure applied for achieving the prescribed objectives, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 shows a perspective, schematic view of the modularized information playback device according to the instant disclosure;

FIG. 2 shows another perspective, schematic view of the modularized information playback device according to the instant disclosure;

FIG. 3 shows a top, schematic view of the modularized information playback device according to the instant disclosure; and

FIG. 4 shows a function block of the modularized information playback device according to the instant disclosure.

### DETAILED DESCRIPTION OF THE PREFERRED EMBODIMENTS

The embodiments of the modularized information playback device of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

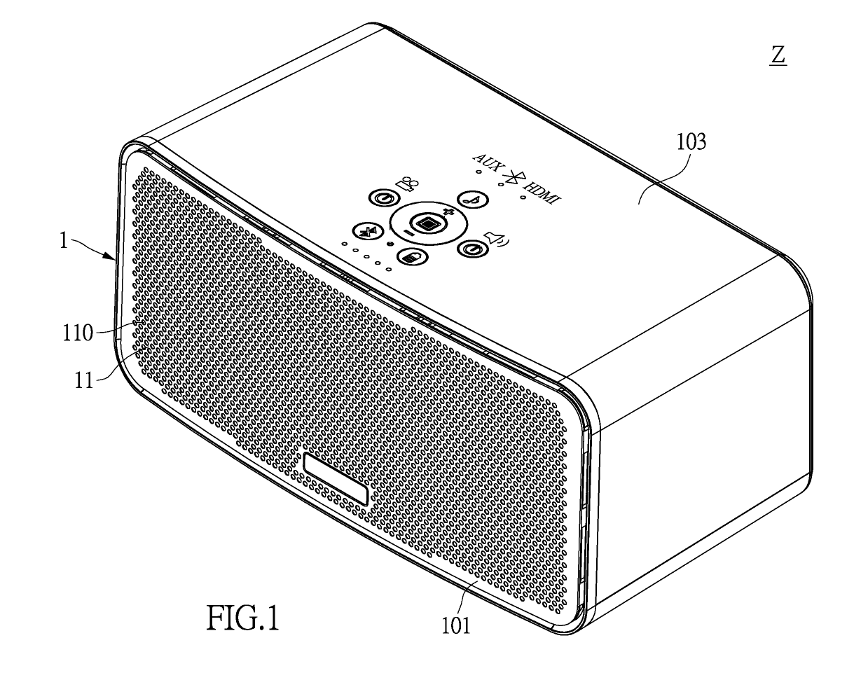

Referring to FIG. 1 to FIG. 4, the instant disclosure provides a modularized information playback device Z (such as a modularized playback for displaying sound and image information), comprising: a casing module 1, a control circuit module 2, a microprojector module 3, a speaker module 4, an audio frequency receiving module 5, a wireless transmission module 6, and a rechargeable battery module 7.

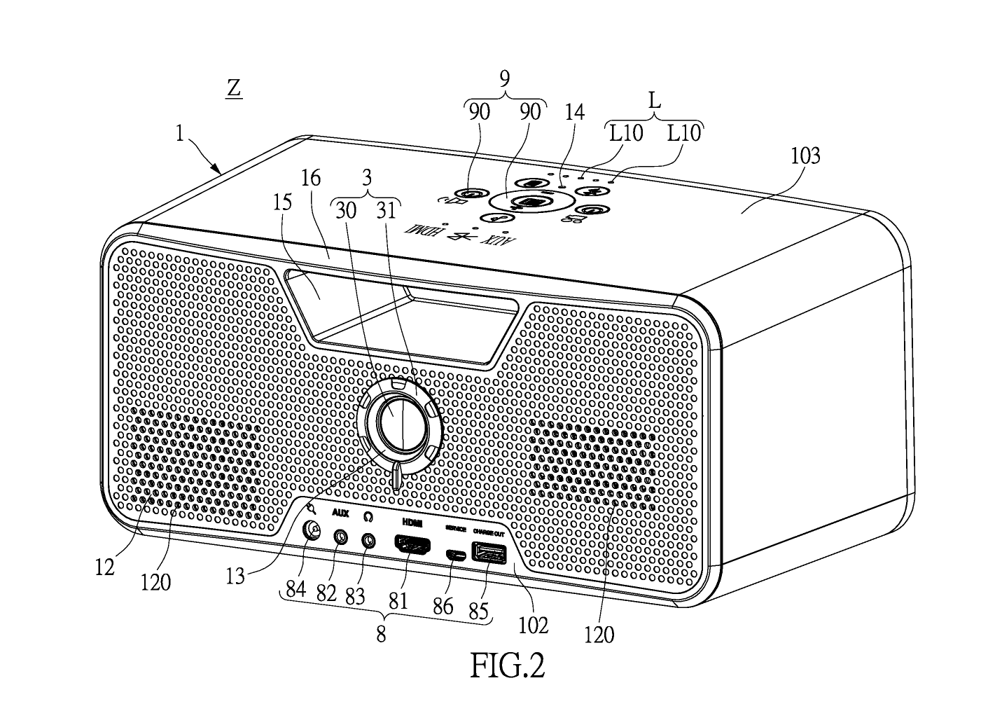

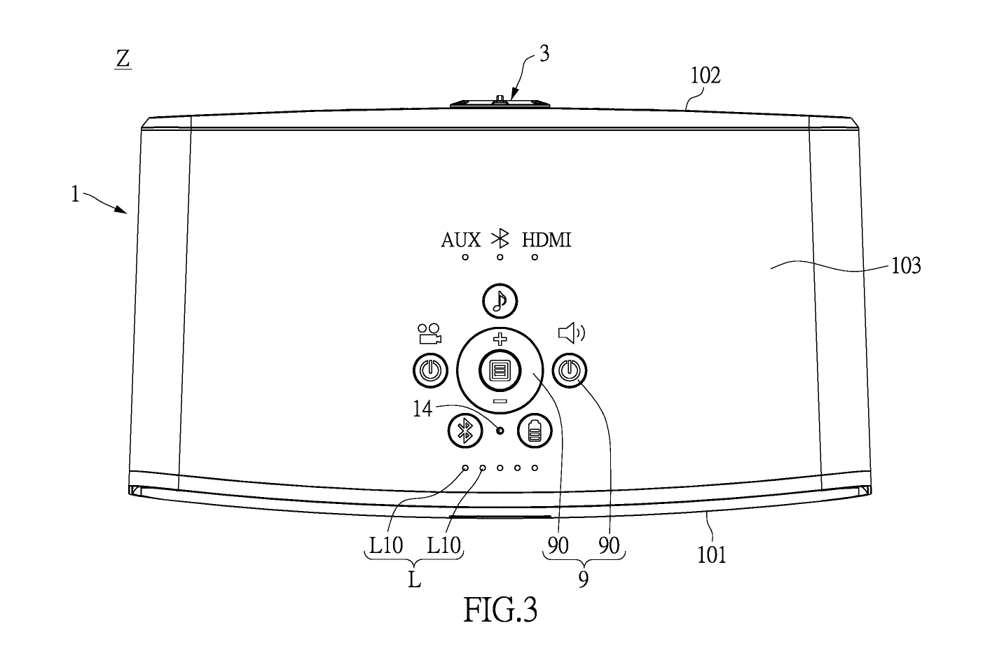

First, referring to FIG. 1, FIG. 2, and FIG. 3, the casing module 1 has a first surface 101 (such as a front surface), a second surface 102 (such as a rear surface) opposite to the first surface 101, and a third surface 103 (such as a top surface) connected between the first surface 101 and the second surface 102. In addition, the casing module 1 includes a first network structure 11 disposed on the first surface 101, a second network structure 12 disposed on the second surface 102, an image projection opening 13 disposed on the second surface 102, and an audio frequency receiving opening 14 (such as an opening for microphone receiver) disposed on the third surface 103, a gripping groove 15 disposed on the second surface 102, and a gripping portion 16 adjacent to the gripping groove 15. More particularly, the first network structure 11 such as a loudspeaker mesh has a plurality of first through holes 110, and the second network structure 12 has a plurality of second through holes 120 such as heat-dissipating hole.

Please note, the forefinger, the middle finger, the ring finger, and the little finger of the user can be inserted into the gripping groove 15, and the thumb of the user can touch the third surface 103 of the casing module 1, such that it is very convenient for the user to carry the modularized information playback device Z by holding or gripping the gripping portion 16.

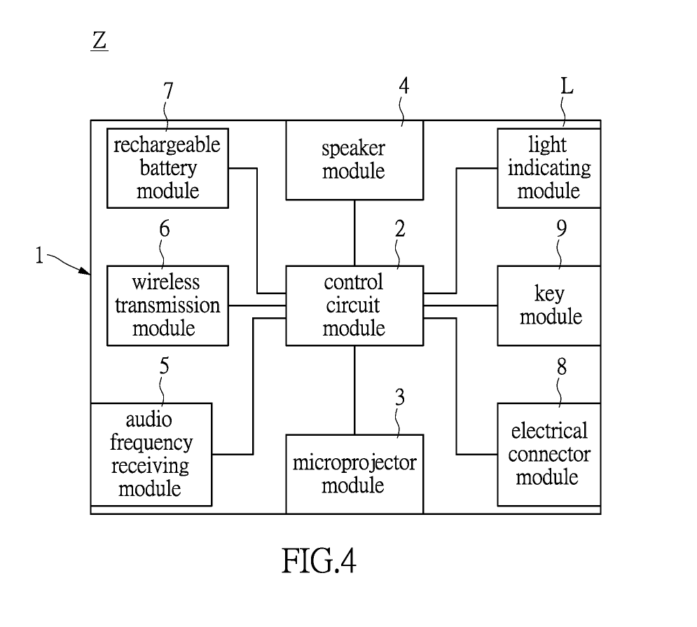

Moreover, referring to FIG. 2, FIG. 3, and FIG. 4, the control circuit module 2 is disposed inside the casing module 1. The microprojector module 3 is disposed inside the casing module 1 and electrically connected to the control circuit module 2, and the microprojector module 3 includes a projection lens assembly 30 partially exposed from the image projection opening 13 and a focus adjusting component 31 disposed on the second surface 102 of the casing module 1 for adjust focal length of the projection lens assembly 30. The speaker module 4 is disposed inside the casing module 1 and electrically connected to the control circuit module 2, and the speaker module 4 is adjacent to the first network structure 11. The audio frequency receiving module 5 is disposed inside the casing module 1 and electrically connected to the control circuit module 2, and the audio frequency receiving module 5 is adjacent to the audio frequency receiving opening 14. The wireless transmission module 6 (such as Bluetooth module) is disposed inside the casing module 1 and electrically connected to the control circuit module 2, and the rechargeable battery module 7 is disposed inside the casing module 1 and electrically connected to the control circuit module 2.

More particularly, referring to FIG. 2, FIG. 3, and FIG. 4, the modularized information playback device Z further comprising: an electrical connector module 8 disposed on the second surface 102 of the casing module 1 and electrically connected to the control circuit module 2. For example, the electrical connector module 8 includes an image and audio signal transmission interface 81 (such as HDMI interface), an audio signal transmission interface 82 (such as AUX interface), an audio signal output interface 83, a power input interface 84, a power output interface 85, and a messaging application programming interface 86, but that is merely an example and is not meant to limit the instant disclosure.

More particularly, referring to FIG. 2, FIG. 3, and FIG. 4, the modularized information playback device Z further comprising: a key module 9 disposed on the third surface 103 of the casing module 1 and electrically connected to the control circuit module 2, and the key module 9 includes a plurality of function keys 90 disposed on the third surface 103 of the casing module 1. For example, the function key 90 may be a start key for turning on HDMI interface function, AUX interface function, Bluetooth function, or power display function etc., but that is merely an example and is not meant to limit the instant disclosure.

More particularly, referring to FIG. 2, FIG. 3, and FIG. 4, the modularized information playback device Z further comprising: a light indicating module L disposed on the third surface 103 of the casing module 1 and electrically connected to the control circuit module 2, and the light indicating module L includes a plurality of indicator lamps L10 disposed on the third surface 103 of the casing module 1. For example, the indicator lamp L10 may be a HDMI interface indicator lamp, an AUX interface indicator lamp, a Bluetooth indicator lamp, or a power indicator lamp etc., but that is merely an example and is not meant to limit the instant disclosure.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. A modularized information playback device, comprising:
a casing module having a first surface, a second surface opposite to the first surface, and a third surface connected between the first surface and the second surface, wherein the casing module includes a first network structure disposed on the first surface, a second network structure disposed on the second surface, an image projection opening disposed on the second surface, and an audio frequency receiving opening disposed on the third surface;
a control circuit module disposed inside the casing module;
a microprojector module disposed inside the casing module and electrically connected to the control circuit module, wherein the microprojector module includes a projection lens assembly partially exposed from the image projection opening;
a speaker module disposed inside the casing module and electrically connected to the control circuit module, wherein the speaker module is adjacent to the first network structure;
an audio frequency receiving module disposed inside the casing module and electrically connected to the control circuit module, wherein the audio frequency receiving module is adjacent to the audio frequency receiving opening;
a wireless transmission module disposed inside the casing module and electrically connected to the control circuit module; and
a rechargeable battery module disposed inside the casing module and electrically connected to the control circuit module.

2. The modularized information playback device of claim 1, further comprising: an electrical connector module disposed on the second surface of the casing module and electrically connected to the control circuit module, wherein the electrical connector module includes an image and audio signal transmission interface, an audio signal transmission interface, an audio signal output interface, a power input interface, a power output interface, and a messaging application programming interface.

3. The modularized information playback device of claim 1, further comprising: a key module disposed on the third surface of the casing module and electrically connected to the control circuit module, wherein the key module includes a plurality of function keys disposed on the third surface of the casing module.

4. The modularized information playback device of claim 1, further comprising: a light indicating module disposed on the third surface of the casing module and electrically connected to the control circuit module, wherein the light indicating module includes a plurality of indicator lamps disposed on the third surface of the casing module.

5. A modularized information playback device, comprising:
a casing module including a first network structure, an image projection opening, and an audio frequency receiving opening;
a control circuit module disposed inside the casing module;
a microprojector module disposed inside the casing module and electrically connected to the control circuit module, wherein the microprojector module includes a projection lens assembly partially exposed from the image projection opening;
a speaker module disposed inside the casing module and electrically connected to the control circuit module, wherein the speaker module is adjacent to the first network structure;
an audio frequency receiving module disposed inside the casing module and electrically connected to the control circuit module, wherein the audio frequency receiving module is adjacent to the audio frequency receiving opening; and
a wireless transmission module disposed inside the casing module and electrically connected to the control circuit module.

6. The modularized information playback device of claim 5, further comprising: an electrical connector module disposed on the casing module and electrically connected to the control circuit module, wherein the electrical connector module includes an image and audio signal transmission interface, an audio signal transmission interface, an audio signal output interface, a power input interface, a power output interface, and a messaging application programming interface.

7. The modularized information playback device of claim 5, further comprising: a key module disposed on the casing module and electrically connected to the control circuit module, wherein the key module includes a plurality of function keys disposed on the casing module.

8. The modularized information playback device of claim 5, further comprising: a light indicating module disposed on the casing module and electrically connected to the control circuit module, wherein the light indicating module includes a plurality of indicator lamps disposed on the casing module.

9. A modularized information playback device, comprising:
a casing module;
a control circuit module disposed inside the casing module;
a microprojector module disposed inside the casing module and electrically connected to the control circuit module;
a speaker module disposed inside the casing module and electrically connected to the control circuit module;
an audio frequency receiving module disposed inside the casing module and electrically connected to the control circuit module;
a wireless transmission module disposed inside the casing module and electrically connected to the control circuit module;
a rechargeable battery module disposed inside the casing module and electrically connected to the control circuit module;
an electrical connector module disposed on the casing module and electrically connected to the control circuit module;
a key module disposed on the casing module and electrically connected to the control circuit module; and
a light indicating module disposed on the casing module and electrically connected to the control circuit module.

10. The modularized information playback device of claim 9, wherein the casing module has a first surface, a second surface opposite to the first surface, and a third surface connected between the first surface and the second surface, and the casing module includes a first network structure disposed on the first surface, a second network structure disposed on the second surface, an image projection opening disposed on the second surface, an audio frequency receiving opening disposed on the third surface, a gripping groove disposed on the second surface of the casing module, and a gripping portion adjacent to the gripping groove, wherein the microprojector module includes a projection lens assembly partially exposed from the image projection opening, the speaker module is adjacent to the first network structure, and the audio frequency receiving module is adjacent to the audio frequency receiving opening, wherein the electrical connector module includes an image and audio signal transmission interface, an audio signal transmission interface, an audio signal output interface, a power input interface, a power output interface, and a messaging application programming interface, the key module includes a plurality of function keys disposed on the third surface of the casing module, and the light indicating module includes a plurality of indicator lamps disposed on the third surface of the casing module.
